(19) United States
(12) Patent Application Publication
(10) Pub. No.: US 2007/0054123 A1
(43) Pub. Date: Mar. 8, 2007

(54) Oval-spherical organic polymer particles and method of production

(75) Inventors: Toshifumi Hashiba, Chiba-shi (JP); Kazutoshi Hayakawa, Chiba-shi (JP); Chihiro Fujii, Chiba-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NISSHINBO INDUSTRIES, INC., Tokyo (JP)

(21) Appl. No.: 11/512,230

(22) Filed: Aug. 30, 2006

(30) Foreign Application Priority Data
Sep. 2, 2005 (JP) 2005-255319

(51) Int. Cl. B32B 1/00

(52) U.S. Cl. 428/407; 526/346

(57) ABSTRACT

An oval-spherical organic polymer particle having a single continuous curved surface and a high aspect ratio of 1.8 or more is disclosed. The particle is composed of a polymer of a first organic monomer having an ionic functional group and a polymerizable group and a second organic monomer which is polymerizable therewith. The particle enables improved optical characteristics such as light scattering and light collecting properties and improved friction characteristics such as slip to be achieved.

### CROSS-REFERENCE TO RELATED APPLICATION

This non-provisional application claims priority under 35 U.S.C. §119(a) on Patent Application No. 2005-255319 filed in Japan on Sep. 2, 2005, the entire contents of which are hereby incorporated by reference.

### BACKGROUND OF THE INVENTION

1. Field of the Invention

The present invention relates to oval-spherical organic polymer particles and a method of producing such particles.

2. Prior Art

Micron-size high aspect-ratio particles are used as fillers and test substances in a variety of fields, including electrical and electronic materials, optical materials, building materials, biological and pharmaceutical materials, and cosmetics.

Most commonly used high aspect-ratio particles are composed of inorganic materials such as metal oxides.

Because such inorganic materials have a high specific gravity compared with organic substances, in some applications, including films and other shaped articles, they can be difficult to uniformly disperse and tend to be incompatible with resins, which sometimes has undesirable consequences in the shaped articles and their performances.

However, recent work on resin particles has led to the development of resin particles which, unlike the particles of indefinite or spherical shape obtained by conventional, widely used particle forming techniques such as grinding or solution polymerization, have discoidal, flattened or other distinctive shapes (see, for example, JP-B 6-53805, JP-A 5-317688 and JP-A 2000-38455).

Because these particles have a number of characteristics, including opacifying properties, whiteness and light diffusing properties, which are superior to those of conventional spherical particles, they are being used in a variety of fields as, for example, electrostatic developers (JP-A 8-202074), paper coatings for recording paper and the like (JP-A 2-14222), adhesives (JP-B 2865534), and light diffusing sheets (JP-A 2000-39506).

At the same time, although such particles are all plate-like, compared with platy particles made of inorganic compounds such as talc or mica, considerable improvement remains to be made in terms of such characteristics as slip, light collecting properties and light diffusing properties.

To enhance these characteristics, resin particles with a distinctive shape composed of two curved surfaces formed with reference to a boundary line have recently been described (International Application WO 01/070826). Ways of improving, for example, slip, light collecting properties and light diffusing properties have been investigated using these resin particles.

Such characteristics are strongly influenced by the size and aspect ratio of the particles. Yet, it is difficult to produce micron-size particles having a high aspect ratio by the method of International Application WO 01/070826. Further improvements are thus being sought with respect to both the particle size and shape.

Organic particles having a high aspect ratio can also be produced by mechanical methods which involve various operations, such as melting, spinning and cutting. However, with these methods, it is technically difficult to achieve a micron-scale particle size, in addition to which adapting these methods to mass production is time and labor intensive. Moreover, such mechanical methods do not lend themselves easily to the production of high-precision oval-spherical particles which are thick in the middle and become progressively more slender toward either pole, and which are free of fracture planes.

Hence, no high aspect-ratio, micron-size, oval-spherical organic particles endowed with a smooth, spherical surface which are capable of exhibiting a broad range of improved properties, including optical properties such as light scattering and light collecting properties, friction properties such as slip, material strength properties such as adhesion, cohesion and, in shaped articles, impact and tensile strengths, cleanability while retaining developer chargeability, and flatting and opacifying properties in coatings, have previously been known.

### SUMMARY OF THE INVENTION

It is therefore an object of the invention to provide high-aspect-ratio oval-spherical organic polymer particles which have improved optical characteristics such as light scattering properties and light collecting properties, and improved friction characteristics such as slip. A further object of the invention is provide a method of producing such particles.

As a result of extensive investigations, we have discovered that, in an oval-spherical organic polymer particle which has a single continuous curved surface and onto which ionic functional groups have been introduced, by having the aspect ratio P₁ calculated from the major axis L₁ and the minor axis D₁ of a projected two-dimensional image obtained by shining light onto the particle from a direction orthogonal to the long axis of the particle be 1.8 or more, it is possible to improve, for example, optical characteristics such as light scattering properties and light collecting properties. We have also found that such oval-spherical organic polymer particles can be easily and efficiently produced chemically by solution polymerization in a solvent mixture composed of water and a water-soluble organic solvent.

Accordingly, in a first aspect, the invention provides an oval-spherical organic polymer particle composed of a polymer of a first organic monomer having an ionic functional group and a polymerizable group and a second organic monomer that is polymerizable therewith. The particle has a single continuous curved surface and an aspect ratio P₁, calculated as P₁=L₁/D₁, wherein L₁ is the major axis and D₁ is the minor axis of a projected two-dimensional image obtained by shining light onto the particle from a direction orthogonal to the long axis of the particle, which satisfies the relationship P₁≧1.8.

The major axis L₁ preferably has an average length L₁ₐ of from 0.001 to 80 μm. The polymer particle typically has a melting point of at least 120° C. The first organic monomer in the polymer of which the particle is composed may be water-soluble.

In a second aspect, the invention provides a method of producing the oval-spherical organic polymer particle of the above first aspect of the invention, which method includes the step of solution polymerizing the first organic monomer having an ionic functional group and a polymerizable group with the second organic monomer that is polymerizable therewith in a solvent mixture of water and a water-soluble organic solvent.

In the particle production method, it is preferable for the first organic monomer and the second organic monomer to be used in a ratio of from 10:90 to 40:60. The first organic monomer may be water-soluble.

In a third aspect, the invention provides a resin composition which contains the oval-spherical organic polymer particle of the above first aspect of the invention.

In a fourth aspect, the invention provides a light-diffusing sheet obtained using the oval-spherical organic polymer particle of the first aspect of the invention.

Because the oval-spherical organic polymer particle of the invention has a single continuous curved surface and a high aspect ratio of 1.8 or more, not only does it have a high light diffusing ability, it can diffuse light in a state of high optical transparency.

Also, because the particle of the invention is composed largely of organic components, the refractive index of the resin can be easily modified by using the particle as a resin additive. Moreover, the particle can be given a small size, enabling closest filling to be achieved, and thus greatly facilitating changes in the light diffusing ability and refractive index. Accordingly, the oval-spherical organic polymer particles of the invention can be advantageously used as an additive for light-diffusing sheets.

Furthermore, because the inventive particle is an organic polymer particle and has a low specific gravity compared with inorganic particles, when used as an additive in various types of resins, it readily disperses in the resin to which it is added and has an excellent compatibility with the resin. Therefore, films and other plastic products obtained by shaping resin compositions containing these particles and various resins have excellent mechanical properties such as strength.

In addition, because the inventive particle is composed largely of organic components, an inorganic or organic coating treatment can easily be administered to the surface of the particle, enabling the production of functional capsules. Moreover, because the inventive particles have ionic functional groups, by modifying these functional groups, it is possible to produce multifunctional particles.

Also, inasmuch as the inventive particle is composed largely of organic components, coloration using pigments or dyes, for example, can easily be carried out, enabling use of the particle in colored material applications such as coatings and toner materials.

Such high-aspect-ratio oval-spherical organic polymer particles, when subjected to treatment such as plating or vacuum discharge deposition, can be employed in new applications as electrically conductive particles for use in conductive materials, such as fillers for electromagnetic shielding, electrically conductive fillers which impart conductivity to plastic materials, and other conductive materials such as for connecting the electrodes of a liquid-crystal display panel with a driving LSI chip, for connecting LSI chips to circuit boards, and for connecting between other very small-pitch electrode terminals.

Because the oval-spherical organic polymer particle of the invention has a high aspect ratio and is easily prepared to a micron size, it can be employed as a filler or test substance in various fields, including electrical and electronic materials, optical materials, building materials, biological and pharmaceutical materials, and cosmetics.

### BRIEF DESCRIPTION OF THE DIAGRAMS

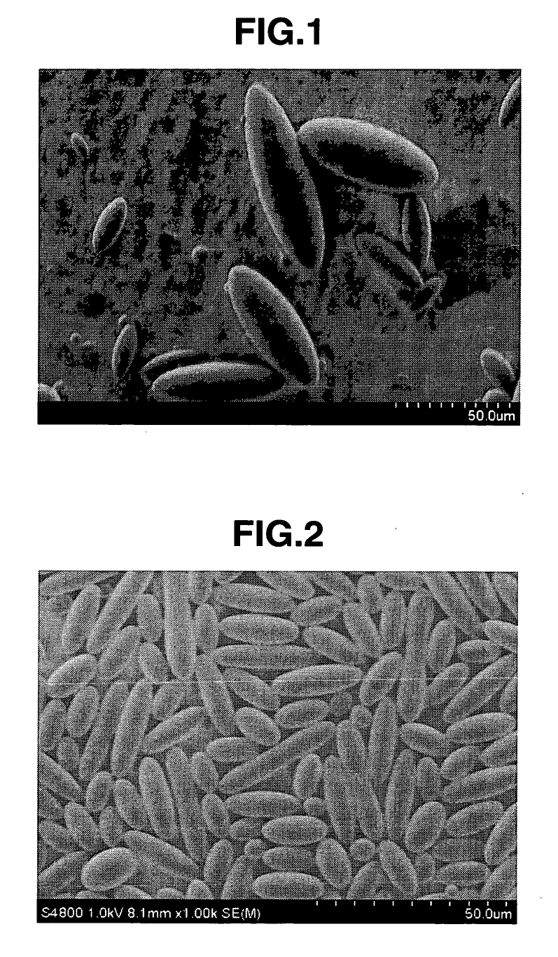

FIG. 1 is a scanning electron micrograph of oval-spherical organic polymer particles obtained in Example 1.

FIG. 2 is a scanning electron micrograph of oval-spherical organic polymer particles obtained in Example 3.

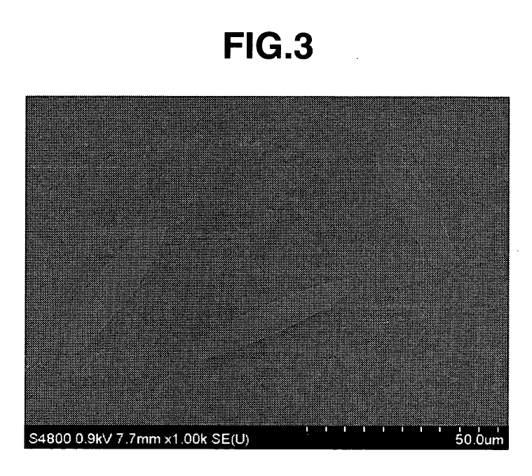

FIG. 3 is a scanning electron micrograph of oval-spherical organic polymer particles obtained in Example 5.

### DETAILED DESCRIPTION OF THE INVENTION

The oval-spherical organic polymer particle of the invention is composed of a polymer of a first organic monomer having an ionic functional group and a polymerizable group and a second organic monomer that is polymerizable therewith. The particle has a single continuous curved surface and has an aspect ratio P₁, calculated as P₁=L₁/D₁, wherein L₁ is the major axis and D₁ is the minor axis of a projected two-dimensional image obtained by shining light onto the particle from a direction orthogonal to the long axis of the particle, which satisfies the relationship P₁≧1.8.

“A single continuous curved surface” refers herein to a smooth curved surface which is free of boundary lines and breaks.

In the practice of the invention, the aspect ratio P₁ in a projected two-dimensional image obtained by shining light onto the particle from a direction orthogonal to the long axis of the particle is ≧1.8. However, for good light diffusing properties and good retention of the shape of the oval-spherical organic polymer particle (i.e., hardness) when rendered into a composition, it is preferable for 1.8≦P₁≦20, more preferable for 2.0≦P₁≦15, and most preferable for 2.2≦P₁≦10.

Moreover, it is preferable for the shape of the oval-spherical organic polymer particle as seen from the long axis direction of the particle (which shape is synonymous With the shape of the projected two-dimensional image obtained by shining light onto the particle from the long axis direction) to be substantially circular or elliptical with a major axis to minor axis ratio close to 1.

The major axis L₁ of the projected two-dimensional image obtained by shining light onto the oval-spherical organic polymer particle of the invention from a direction orthogonal to the long axis of the particle has an average length L₁ₐ of from 0.001 to 80 μm, preferably from 0.05 to 70 μm, more preferably of 0.1 to 60 μm, even more preferably of 0.5 to 50 μm, and most preferably of 1 to 40 μm. Particles with a major axis L₁ having an average length L₁ₐ of more than 80 μm can be produced, but there is little benefit in doing so, particularly in connection with cosmetics and in the area of electrical and electronic materials requiring light diffusibility. At an average major axis length L₁ₐ of less than 0.001 μm, the particle has a size so small as to be prone to agglomeration with other particles, making it very likely that monodispersed particles cannot be obtained.

The ionic functional groups on the organic polymer particle may be anionic functional groups or cationic functional groups. Examples of anionic functional groups include carboxyl groups, sulfonic acid groups, phosphoric acid groups, phenolic hydroxyl groups, and salts thereof. Examples of cationic functional groups include amino groups, imidazole groups, pyridine groups, amidino groups, and salts thereof.

Anionic functional groups are especially preferred on account of the many general-purpose products and the large choice of types available, and also because they make it possible to efficiently control the size, shape and other properties of the oval-spherical particle. Of these, the use of one or more type of functional group selected from among carboxyl groups, sulfonic acid groups, phosphoric acid groups and derivatives thereof are particularly preferable because they are easy to introduce onto molecules and have an excellent stability and safety.

Examples of counterions to these ionic functional groups include, for anionic functional groups, metal cations, ammonium cations, pyridinium cations and phosphonium cations; and for cationic functional groups, the ions of halide salts such as chlorides, bromides and iodides.

When an anionic functional group is used, for reasons having to do with production costs, the large choice of types available, and the ability to efficiently control such characteristics of oval-spherical particles as their precision, size and shape, it is most preferable for the counterion to be a metal cation.

Illustrative examples of suitable metal cations include non-transition metal cations such as alkali metal cations (e.g., lithium, sodium, rubidium, cesium), alkaline earth metal cations (e.g., magnesium, calcium, strontium, barium), and aluminum; and transition metal-containing cations, including the oxides, hydroxides and carbonates of transition metals such as zinc, copper, manganese, nickel, cobalt, iron and chromium.

The method of introducing the ionic functional groups is not subject to any particular limitation. Illustrative examples include methods which involve the subsequent modification of a resin prepared from a nonionic monomer as the starting material, and methods which involve the polymerization of an ionic functional group-bearing monomer as the starting material. The latter approach is preferable from the standpoint of the reliability and ease of introducing the ionic functional groups, lowering the production costs, and reliably obtaining oval-spherical organic polymer particles having a high aspect ratio.

No particular limitation is placed on the molecular weight of the polymer making up the particle, although the weight-average molecular weight, as measured by gel permeation chromatography, is generally about 1,000 to 3,000,000.

When a resin composition containing the oval-spherical organic polymer particles of the invention is formed into a light-diffusing plate or sheet, for such a product to manifest a sufficient heat resistance at elevated temperatures, it is preferable that the oval-spherical organic polymer particles have a melting point of at least 120° C.

The oval-spherical polymer particle of the invention has a relatively high melting point which appears to be attributable to the ionic functional groups. By varying such conditions as the type or amount of the ionic functional groups, the melting point can be set to 120° C. or more and, in some cases, 130° C. or more, or even 150° C. or more.

The melting point referred to herein is the temperature at which a melting peak is observed on measurement with a differential scanning calorimeter (DSC 6200; manufactured by Seiko Instrument).

Oval-spherical organic polymer particles such as the above may be produced by solution polymerizing, in a solvent mixture of water and a water-soluble organic solvent, a first organic monomer having an ionic functional group and a polymerizable group with a second organic monomer that is polymerizable therewith. Here, if a monomer lacking an ionic functional group is used, the resulting particles will tend to be spherical, making it highly unlikely that oval-spherical particles having an aspect ratio like that described above can be obtained. The reason, while not entirely clear, appears to have something to do with the change in surface tension that takes place during particle formation when an ionic functional group is present on the monomer.

The use of dispersion polymerization as the solution polymerization process is preferred because subsequent treatment such as washing is easy and the particle size of the oval-spherical organic polymer particles obtained is easy to control.

The first organic monomer having an ionic functional group may be an anionic functional group-bearing monomer or a cationic functional group-bearing monomer. The polymerizable group is not subject to any particular limitation, provided it is a polymerizable functional group. Suitable examples include reactive functional groups such as carbon-carbon unsaturated bonds, hydroxyl groups, amino groups, epoxy groups, thiol groups, isocyanate groups, oxazoline groups and carbodiimide groups.

Exemplary first organic monomers having an anionic functional group include monocarboxylic acid monomers, dicarboxylic acid monomers, sulfonic acid monomers, sulfate ester monomers, phenolic hydroxyl group-bearing monomers and phosphoric acid monomers.

Illustrative examples of monocarboxylic acid monomers include (meth)acrylic acid, crotonic acid, cinnamic acid, mono-C₁₋₈ alkyl esters of maleic acid, mono-C₁₋₈ alkyl esters of itaconic acid, vinylbenzoic acid, and salts thereof.

Examples of dicarboxylic acid monomers include maleic acid and its anhydride, α-methylmaleic acid and its anhydride, α-phenylmaleic acid and its anhydride, fumaric acid, itaconic acid, and salts thereof.

Examples of sulfonic acid monomers include alkenesulfonic acids such as ethylenesulfonic acid, vinylsulfonic acid and (meth)allylsulfonic acid; aromatic sulfonic acids such as styrenesulfonic acid and α-methylstyrenesulfonic acid; C₁₋₁₀ alkyl(meth)allylsulfosuccinic acid esters; sulfo-C₂₋₆ alkyl(meth)acrylates such as sulfopropyl(meth)acrylate; and sulfonic acid group-bearing unsaturated esters such as methyl vinyl sulfonate, 2-hydroxy-3-(meth)acryloxypropylsulfonic acid, 2-(meth)acryloylamino-2,2-dimethylethanesulfonic acid, 3-(meth)acryloyloxyethanesulfonic acid, 3-(meth)acryloyloxy-2-hydroxypropanesulfonic acid, 2-(meth)acrylamido-2-methylpropanesulfonic acid and 3-(meth)acrylamido-2-hydroxypropanesulfonic acid; and salts thereof.

Examples of sulfate ester monomers include (meth)acryloyl polyoxyalkylenes (degree of polymerization, 2 to 15) sulfate esters such as polyoxypropylene monomethacrylate sulfate ester, and salts thereof.

Examples of phenolic hydroxyl group-bearing monomers include hydroxystyrene, bisphenol A monoallyl ether, bisphenol A mono(meth)acrylate esters, and salts thereof.

Examples of phosphoric acid monomers include (meth)acryloyl hydroxyalkyl phosphate monoesters such as 2-hydroxyethyl(meth)acryloyl phosphate and phenyl-2-acryloyloxy ethyl phosphate; and vinylphosphoric acid.

Examples of the salts in this case include alkali metal salts such as sodium salts and potassium salts, amine salts such as triethanolamine, and quaternary ammonium salts such as tetra-C₄₋₁₈ alkylammonium salts.

Exemplary monomers having a cationic functional group include primary amino group-bearing monomers, secondary amino group-bearing monomers, tertiary amino group-bearing monomers, quaternary ammonium salt group-bearing monomers, heterocycle-bearing monomers, phosphonium group-bearing monomers, sulfonium group-bearing monomers and sulfonic acid group-bearing polymerizable unsaturated monomers.

Examples of primary amino group-bearing monomers include C₃₋₆ alkenylamines such as (meth)allylamine and crotylamine; amino C₂₋₆ alkyl(meth)acrylates such as aminoethyl(meth)acrylate; monomers having an aromatic ring and a primary amino group, such as vinylaniline and p-aminostyrene; and ethylenediamine and polyalkylene polyamines.

Examples of secondary amino group-bearing monomers include C₁₋₆ alkylamino C₂₋₆ alkyl(meth)acrylates such as t-butylaminoethyl methacrylate and methylaminoethyl(meth)acrylate; C₆₋₁₂ dialkenylamines such as di(meth)allylamine; and ethyleneimine and diallylamine.

Examples of tertiary amino group-bearing monomers include di(C₁₋₄ alkylamino C₂₋₆ alkyl)(meth)acrylates such as N,N-dimethylaminoethyl(meth)acrylate, N,N-diethylaminoethyl(meth)acrylate, N,N-dimethylaminopropyl(meth)acrylate, N,N-diethylaminopropyl(meth)acrylate, N,N-dibutylaminoethyl(meth)acrylate, N-t-butylaminoethyl(meth)acrylate and N,N-dimethylaminobutyl(meth)acrylate; di(C₁₋₄ alkylamino C₂₋₆ alkyl)(meth)acrylamides such as N,N-dimethylaminoethyl(meth)acrylamide and N,N-dimethylaminopropyl(meth)acrylamide; and monomers having an aromatic ring and a tertiary amino group, such as N,N-dimethylaminostyrene.

Exemplary quaternary ammonium salt group-bearing monomers include tertiary amines that have been quaternized using a quaternizing agent such as a C₁₋₁₂ alkyl chloride, a dialkyl sulfuric acid, a dialkyl carbonate or benzyl chloride.

Specific examples include alkyl(meth)acrylate-type quaternary ammonium salts such as (2-((meth)acryloyloxy)ethyl)trimethylammonium chloride, (2-((meth)acryloyloxy)ethyl)trimethylammonium bromide, ((meth)acryloyloxy)ethyl)triethylammonium chloride, ((meth)acryloyloxy)ethyl)dimethylbenzylammonium chloride and ((meth)acryloyloxy)ethyl)methylmorpholinoammonium chloride; alkyl(meth)acrylamide-type quaternary ammonium salts such as ((meth)acryloylamino)ethyl)trimethylammonium chloride, (meth))acryloylamino)ethyl)trimethylammonium bromide, ((meth)acryloylamino)ethyl)triethylammonium chloride and ((meth)acryloylamino)ethyl)dimethylbenzylammonium chloride; and other quaternary ammonium salt group-bearing monomers such as dimethyldiallylammonium methyl sulfate, trimethylvinylphenylammonium chloride, tetrabutylammonium(meth)acrylate, trimethylbenzylammonium(meth)acrylate and 2-(methacryloyloxy)ethyltrimethylammonium dimethylphosphate.

Examples of heterocycle-bearing monomers include N-vinylcarbazole, N-vinylimidazole, N-vinyl-2,3-dimethylimidazoline, N-methyl-2-vinylimidazoline, 2-vinylpyridine, 4-vinylpyridine, N-methylvinylpyridine and oxyethyl-1-methylenepyridine.

Phosphonium group-bearing monomers are exemplified by glycidyl tributylphosphone.

Examples of sulfonium group-bearing monomers include 2-acryloxyethyldimethyl sulfone and glycidyl methylsulfonium.

Examples of sulfonic acid group-bearing polymerizable unsaturated monomers include (meth)acrylamidoalkanesulfonic acids such as 2-acrylamido-2-methylpropanesulfonic acid, and sulfoalkyl(meth)acrylates such as 2-sulfoethyl (meth)acrylate.

The above-mentioned cationic functional group-bearing monomers may be used in the form of inorganic acid salts such as hydrochlorides and phosphates, or in the form of organic salts such as formates and acetates.

The letter “C” as used above in the description of the first organic monomer refers to the number of carbons.

In particular, it is preferable for the first organic monomer to be a water-soluble monomer. By using a water-soluble monomer, the particle size of the resulting oval-spherical organic polymer particles can be made smaller.

Specific examples of the water-soluble monomer include (meth)acrylic acid, ethylenesulfonic acid, vinylsulfonic acid, (meth)allylsulfonic acid, styrenesulfonic acid, α-methylstyrene sulfonic acid, 2-hydroxy-2-(meth)acryloxypropylsulfonic acid, 2-(meth)acryloylamino-2,2-dimethylethanesulfonic acid, 3-(meth)acryloyloxyethanesulfonic acid, 3-(meth)acryloyloxy-2-hydroxypropanesulfonic acid, 2-(meth)acrylamido-2-methylpropanesulfonic acid, 3-(meth)acrylamido-2-hydroxypropanesulfonic acid, and salts thereof; (meth)acryloylpolyoxyalkylene (degree of polymerization (n)=2 to 15) sulfate esters such as polyoxypropylene monomethacrylate sulfate esters, and salts thereof; 2-hydroxyethyl(meth)acryloylphosphate; acrylamide, ethylenediamine and N,N-dimethylaminoethyl(meth)acrylate; quaternary ammonium salt group-bearing monomers such as [2-((meth)acryloyloxy)ethyl]trimethylammonium chloride, [2-((meth)acryloyloxy)ethyl]trimethylammonium bromide, [(meth)acryloyloxyethyl]triethylammonium chloride and [(meth)acryloylaminoethyl]trimethylammonium chloride; and 2-vinylpyridine, 4-vinylpyridine and 2-acryloamido-2-methylpropanesulfonic acid.

Of these, (meth)acrylic acid, ethylenesulfonic acid, vinylsulfonic acid, (meth)allylsulfonic acid, styrenesulfonic acid, α-methylstyrenesulfonic acid, 2-hydroxy-3-(meth)acryloxypropylsulfonic acid, 2-(meth)acryloylamino-2,2-dimethylethanesulfonic acid, 3-(meth)acryloyloxyethanesulfonic acid, 3-(meth)acryloyloxy-2-hydroxypropanesulfonic acid, and salts thereof; and (meth)acryloylpolyoxyalkylene (n=2 to 15) sulfate esters such as polyoxypropylene monomethacrylate sulfate ester compounds and salts thereof are more preferred.

The anionic functional group-bearing monomers and cationic functional group-bearing monomers mentioned above can be used singly or as combinations of two or more thereof.

The second organic monomer which is polymerizable with the first organic monomer having an ionic functional group should be a monomer selected as appropriate for the polymerizable group on the first organic monomer. Illustrative examples include (i) styrenic monomers such as styrene, o-methylstyrene, m-methylstyrene, p-methylstyrene, α-methylstyrene, p-ethylstyrene, 2,4-dimethylstyrene, p-n-butylstyrene, p-t-butylstyrene, p-n-hexylstyrene, p-n-octylstyrene, p-n-nonylstyrene, p-n-decylstyrene, p-n-dodecylstyrene, p-methoxystyrene, p-phenylstyrene, p-chlorostyrene, and 3,4-dichlorostyrene; (ii) (meth)acrylate ester monomers such as methyl acrylate, ethyl acrylate, n-butyl acrylate, isobutyl acrylate, propyl acrylate, hexyl acrylate, 2-ethylhexyl acrylate, n-octyl acrylate, dodecyl acrylate, lauryl acrylate, stearyl acrylate, 2-chloroethyl acrylate, phenyl acrylate, methyl α-chloroacrylate, methyl methacrylate, ethyl methacrylate, n-butyl methacrylate, isobutyl methacrylate, propyl methacrylate, hexyl methacrylate, 2-ethylhexyl methacrylate, n-octyl methacrylate, dodecyl methacrylate, lauryl methacrylate and stearyl methacrylate; (iii) vinyl ester monomers such as vinyl acetate, vinyl propionate, vinyl benzoate and vinyl butyrate; (iv) (meth)acrylic acid derivatives such as acrylonitrile and methacrylonitrile; (v) vinyl ether monomers such as vinyl methyl ether, vinyl ethyl ether and vinyl isobutyl ether; (vi) vinyl ketone monomers such as vinyl methyl ketone, vinyl hexyl ketone and methyl isopropenyl ketone; (vii) N-vinyl compounds such as N-vinylpyrrole, N-vinylcarbazole, N-vinylindole and N-vinylpyrrolidone; and (viii) fluoroalkyl group-bearing (meth)acrylate ester monomers such as vinyl fluoride, vinylidene fluoride, tetrafluoroethylene and hexafluoropropylene, as well as trifluoroethyl acrylate and tetrafluoropropyl acrylate.

Depending on the polymerizable group in the first organic monomer, it is also possible to use monomers having a reactive functional group such as a hydroxyl group, amino group, epoxy group, thiol group, isocyanate group, oxazoline group or carbodiimide group as the second organic monomer.

These second organic monomers may be used singly or as combinations of two or more thereof.

It is especially preferable for the second organic monomer to be a hydrophobic monomer. By using a hydrophobic monomer, the resulting oval-spherical organic polymer particles can be imparted with an even higher aspect ratio, enabling an ideal oval-spherical shape to be approached.

Preferred examples of the hydrophobic monomer include styrene monomers and (meth)acrylic monomers. These hydrophobic monomers may be used singly or as combinations of two or more thereof. Alternatively, they may be used in combination with one or more other second organic monomer which is not a hydrophobic monomer.

It is especially preferable to use, as the first organic monomer and the second organic monomer, a combination of at least one monomer selected from Group α below with at least one monomer selected from Group β below.

(1) First Organic Monomer—Group α

Salts of styrenesulfonic acids, salts of styrenecarboxylic acids, salts of (meth)acrylic acid, salts of (meth)acrylate carboxylic acids, salts of (meth)acrylate sulfonic acids, salts of vinylsulfonic acids, salts of vinylcarboxylic acids, salts of (meth)acryloylsulfonic acids, salts of (meth)acryloylcarboxylic acids.

(2) Second Organic Monomer—Group β

Styrenic monomers, (meth)acrylic monomers.

No particular limitation is imposed on the ratio in which the above-described first organic monomer and the second organic monomer are used to produce the oval-spherical organic polymer particles of the invention. For example, the weight ratio of the first organic monomer to the second organic monomer may be set in a range of 5:95 to 50:50. To further increase the aspect ratio of the resulting particles and have the shape of the particles approach an ideal oval-spherical shape, the ratio of the first organic monomer to the second organic monomer is preferably from 10:90 to 40:60, and more preferably from 15:85 to 25:75.

To further increase the aspect ratio of the resulting particles and efficiently produce particles have an ideal oval-spherical shape, the combined content of the first organic monomer and the second organic monomer in the reaction solution (which combined content is referred to below as the “polymerization component content”) is preferably from 1 to 80 wt %, more preferably from 5 to 50 wt %, and even more preferably from 10 to 30 wt %, of the entire reaction solution.

At a polymerization component content of more than 80 wt %, the amount of these components becomes excessive, destroying the balance within the solution and readily leading to the formation of spherical particles. As a result, it is difficult to obtain monodispersed oval-spherical particles. On the other hand, at less than 1 wt %, although particles of the desired shape can be obtained, bringing the reaction to completion takes a long time, which is impractical.

The reaction temperature during polymerization will vary with the type of solvent used and cannot be strictly specified, but generally is in a range of about −100 to 200° C., preferably 0 to 150° C., and more preferably 40 to 100° C.

The reaction time is not subject to any particular limitation, so long as it is a length of time sufficient to allow the particles to substantially completely assume oval-spherical shapes. However, the reaction time is largely affected by such factors as the types of monomers and the amounts in which they are included, the types of ionic functional groups, and the viscosity and concentration of the solution. To efficiently produce the target oval-spherical particles having an ideal shape, reaction at 40 to 100° C. is typically carried out for about 2 to 24 hours, and preferably about 8 to 16 hours.

The solvent used in the polymerization reaction is preferably a solvent mixture composed of water and a water-soluble organic solvent. By using such a solvent mixture, the first and second organic monomers can be easily dispersed or dissolved, enabling oval-spherical organic polymer particles having a smaller particle size to be obtained.

Specific examples of water-soluble organic solvents that may be used include methanol, ethanol, 2-propanol, ethylene glycol, propylene glycol, methyl cellosolve, ethyl cellosolve, propyl cellosolve, methyl cellosolve acetate, ethyl cellosolve acetate, methyl carbitol, ethyl carbitol, butyl carbitol, ethyl carbitol acetate, acetone, tetrahydrofuran, dimethylformamide, N-methyl-2-pyrrolidone and acetonitrile. These solvents may be used singly or as mixtures of two or more thereof.

The solvent mixture may have an mixing ratio. For example, the weight ratio of water to the water-soluble organic solvent may be set in a range of 1:99 to 99:1. However, to readily disperse or dissolve the first and second monomers, enhance their copolymerizability, and more efficiently obtain high-aspect-ratio particles of a smaller particle size, the weight ratio of water to the water-soluble solvent is preferably from 10:90 to 80:20, and more preferably from 30:70 to 50:50.

In addition, a suitable amount of a hydrophobic organic solvent may also be admixed within a range that dissolves in the solvent mixture of water and the water-soluble organic solvent.

Any of various known polymerization initiators may be used as the polymerization initiator for carrying out a radical polymerization reaction. Illustrative examples include various types of oil-soluble, water-soluble or ionic polymerization initiators, particularly peroxides such as benzoyl peroxide, cumene hydroperoxide, t-butyl hydroperoxide, sodium persulfate and ammonium persulfate; and azo compounds such as azobisisobutyronitrile, azobismethylbutyronitrile, azobisisovaleronitrile, 2,2′-azobis(2-amidinopropane) dihydrochloride, 2,2′-azobis(N,N′-dimethyleneisobutylamidine) dihydrochloride and disodium 2,2′-azobis-2-cyanopropane-1-sulfonate. These polymerization initiators may be used singly or as a mixture of two or more thereof.

In the production of the oval-spherical organic polymer particles, depending on the method of polymerization, additives such as (polymer) dispersants, stabilizers and emulsifying agents (surfactants) may be included in a suitable amount within a range of 0.01 to 50 wt %, based on the combined weight of the polymerization ingredients.

Examples of suitable dispersants and stabilizers include the following hydrophobic or hydrophilic dispersants and stabilizers: polystyrene derivatives such as polyhydroxystyrene, polystyrene sulfonic acid, vinylphenol-(meth)acrylate copolymers, styrene-(meth)acrylate copolymers and styrene-vinylphenol-(meth)acrylate copolymers; poly(meth)acrylic acid derivatives such as poly(meth)acrylate copolymers, poly(meth)acrylic acid, poly(meth)acrylamide, polyacrylonitrile, poly(ethyl(meth)acrylate) and poly(butyl(meth)acrylate); polyvinyl alkyl ether derivatives such as polymethyl vinyl ether, polyethyl vinyl ether, polybutyl vinyl ether and polyisobutyl vinyl ether; polyalkylene glycol derivatives such as polyethylene glycol and polypropylene glycol; cellulose derivatives such as cellulose, methyl cellulose, cellulose acetate, cellulose nitrate, hydroxymethyl cellulose, hydroxyethyl cellulose, hydroxypropyl cellulose and carboxymethyl cellulose; polyvinyl acetate derivatives such as polyvinyl alcohol, polyvinyl butyral, polyvinyl formal and polyvinyl acetate; nitrogen-bearing polymer derivatives such as polyvinyl pyridine, polyvinyl pyrrolidone, polyethyleneimine and poly(2-methyl-2-oxazoline); polyvinyl halide derivatives such as polyvinyl chloride and polyvinylidene chloride; and polysiloxane derivatives such as polydimethylsiloxane. These may be used singly or as combinations of two or more thereof.

To enable efficient control of the size, shape and other characteristics of the oval-spherical organic polymer particles, these dispersants and stabilizers may be derivatives which include the ionic functional group borne by the first organic monomer.

Illustrative examples of emulsifying agents (surfactants) include anionic emulsifying agents such as alkyl sulfates (e.g., sodium laurylsulfate), alkylbenzene sulfonates (e.g., sodium dodecylbenzene sulfonate), alkylnaphthalene sulfonates, fatty acid salts, alkyl phosphates and alkyl sulfosuccinates; cationic emulsifying agents such as alkylamines, quaternary ammonium salts, alkyl betaine and amine oxides; and nonionic emulsifying agents such as polyoxyethylene alkyl ethers, polyoxyethylene alkylallyl ethers, polyoxyethylene alkylphenyl ethers, sorbitan fatty acid esters, glycerol fatty acid esters and polyoxyethylene fatty acid esters. These may be used singly or as combinations of two or more thereof.

The above dispersant, stabilizer and emulsifying agent are selected and used as appropriate for the reaction solvent. In the present invention, because a solvent mixture of water and a water-soluble organic solvent is used as the reaction solvent, to stabilize the size of the resulting oval-spherical organic polymer particles and efficiently obtain particles of a smaller size, it is preferable to dissolve the dispersant, stabilizer and emulsifying agent in the solvent mixture. Examples of such dispersants and stabilizers include polystyrene derivatives, poly(meth)acrylic acid derivatives, polyvinyl alkyl ether derivatives, polyalkylene glycol derivatives and polyvinylpyrrolidone. Examples of such emulsifying agents include alkyl sulfates such as sodium lauryl sulfate, alkylbenzenesulfonates such as sodium dodecylbenzenesulfonate, alkylnaphthalenesulfonates and nonionic emulsifying agents.

In the practice of the invention, when the polymerization reaction is carried out, depending on such considerations as the intended use of the resulting particles, a crosslinking agent may be included in a suitable amount of from 0.01 to 80 wt %, based on the combined weight of the polymerization components.

Illustrative examples of crosslinking agents include aromatic divinyl compounds such as divinylbenzene and divinylnaphthalene; and compounds such as ethylene glycol diacrylate, ethylene glycol dimethacrylate, triethylene glycol dimethacrylate, tetraethylene glycol dimethacrylate, 1,3-butylene glycol dimethacrylate, trimethylolpropane triacrylate, trimethylolpropane trimethacrylate, 1,4-butanediol diacrylate, neopentyl glycol diacrylate, 1,6-hexanediol diacrylate, pentaerythritol triacrylate, pentaerythritol tetraacrylate, pentaerythritol dimethacrylate, pentaerythritol tetramethacrylate, glycerol acryloxy dimethacrylate, N,N-divinyl aniline, divinyl ether, divinyl sulfide and divinyl sulfone. These may be used singly or as combinations of two or more thereof.

Depending on the intended use of the resulting particles, a catalyst (reaction promoter) may be included in the polymerization reaction. The amount of catalyst used may be a suitable amount that does not exert an adverse influence on the particle properties. For example, an amount of from 0.01 to 20 wt %, based on the combined weight of the polymerization components, may be included.

The catalyst is not subject to any particular limitation, provided it is a positive catalyst. Any suitable known catalyst may be selected and used. Specific examples include tertiary amines such as benzyldimethylamine, triethylamine, tributylamine, pyridine and triphenylamine; quaternary ammonium compounds such as triethylbenzylammonium chloride and tetramethylammonium chloride; phosphines such as triphenylphosphine and tricyclophosphine; phosphonium compounds such as benzyltrimethylphosphonium chloride; imidazole compounds such as 2-methylimidazole and 2-methyl-4-ethylimidazole; alkali metal hydroxides such as potassium hydroxide, sodium hydroxide and lithium hydroxide; alkali metal carbonates such as sodium carbonate and lithium carbonate; alkali metal salts of organic acids; and halides or complex salts thereof which exhibit Lewis acid properties, such as boron trichloride, boron trifluoride, tin tetrachloride and titanium tetrachloride. These may be used singly or as combinations of two or more thereof.

In addition, to adjust such characteristics as the size, shape and quality of the resulting oval-spherical particles, a compound that is capable of dissolving in water or another polar solvent, electrolytically dissociates into cations and anions, and the solution of which exhibits electrical conductivity may also be added at the time of the polymerization reaction.

Illustrative examples include salts, inorganic acids, inorganic bases, organic acids, organic bases and ionic liquids. The amount of addition may be set to a suitable amount which does not have an adverse influence on the particle properties, such as from 0.01 to 80 wt %, based on the combined weight of the polymerization components.

Because the above-described inventive method of production is solution polymerization, a process that enables the particle size to be controlled, precise design of such characteristics as the particle size and shape is possible. As a result, oval-spherical organic polymer particles which are covered with a single continuous and smooth curved surface that is free of fracture planes (or boundary lines) and have the desired aspect ratio can be obtained.

Using this production method, other organic compounds or the like can be directly bonded to the resulting oval-spherical organic polymer particles, enabling particles having a core/shell structure to be continuously and efficiently obtained.

When the inventive method of production is carried out, all of the particles obtained are not organic polymer particles having the target oval-spherical shape. Generally, of a random sampling of 100 of the oval-spherical organic polymer particles obtained, the aspect ratio P₁ of individual particles calculated from the major axis L₁ and minor axis D₁ (P₁=L₁/D₁) of the projected two-dimensional image obtained by shining light onto that particle from a direction orthogonal to the long axis of the particle, averaged for the 100 particles (P₁ₐ), satisfies the relationship P₁ₐ≧1.5. For practical purposes, it is preferable for P₁ₐ≧1.8, more preferable for 1.8≦P₁ₐ≦20, even more preferable for 2.0≦P₁ₐ≦15 and most preferable for 2.2≦P₁ₐ≦10.

The degree of variation A (%) [(standard deviation of P₁)/P₁ₐ]×100 in the aspect ratios P₁ of 100 individual particles that have been randomly sampled in the same way generally satisfies the relationship A≦50. For practical purposes, this degree of variation in the aspect ratio A is preferably ≦30, and more preferably ≦25.

The oval-spherical organic polymer particles preferably have a shape, as seen from the long axis direction, which is close to circular. One method of determining whether the shape is close to circular involves measurement from the projected two-dimensional image obtained by shining light from, for example, the long axis direction of the particle. In this case, the aspect ratio P₂ calculated from the major axis L₂ and minor axis D₂ in the projected two-dimensional image obtained by shining a light from the long axis direction of the particle preferably satisfies the relationship 1.2≧P₂≧1.0.

If determining the aspect ratio P₂ from the projected two-dimensional image obtained by shining light from the long axis direction is difficult, measurement can be carried out by the following method.

Using the above aspect ratio P₁ and the aspect ratio P_{1-45°} calculated from the major axis L₁ and minor axis D_{1-45°} of the projected two-dimensional image obtained by placing an oval-spherical organic polymer particle on a reference plane containing a horizontal axis as an axis of rotation so that the long axis of the particle is aligned with the axis of rotation, and rotating the reference plane 45° about the axis of rotation, the index of spheroidization Q₁ for the projected two-dimensional image that would presumably be obtained by shining light from the long axis direction is computed as follows.
If P_{1-45°}≦P₁, then Q₁=P_{1-45°}/P₁. (1)
If P₁<P_{1-45°}, then Q₁=P₁/P_{1-45°}. (2)

The cross section obtained by cutting the oval-spherical particle orthogonal to the long axis direction becomes more nearly circular the closer this index of spheroidization is to 1, signifying that, three-dimensionally, the polymer particle is of an oval-spherical shape.

The oval-spherical organic polymer particle of the invention has an average index of spheroidization Q₁ₐ which generally satisfies the relationship 0.7≦Q₁ₐ≦1.0, preferably satisfies the relationship 0.8≦Q₁ₐ≦1.0, more preferably satisfies the relationship 0.9≦Q₁ₐ≦1.0, and most preferably satisfies the relationship 0.95≦Q₁ₐ≦1.0.

In the practice of the invention, the operation of rendering individual oval-spherical particles obtained into a two-dimensional state (generally the oval-spherical particle maintains a state in which the long axis is horizontally oriented ) by using a scanning electron microscope (S-4800 manufactured by Hitachi High-Technologies Corporation; sometimes referred to below as “SEM”) to take a photograph at a measurable magnification (from 300 to 20,000×), measuring the major axis L₁ and minor axis D₁ of each particle in this state and calculating the aspect ratio P₁, and the operation of likewise, from the above state, setting an oval-spherical organic polymer particle on a microscope stage having an axis provided in the horizontal direction as an axis of rotation so that the long axis of the oval-spherical organic polymer particle is aligned with the axis of rotation, rotating the reference plane (in this case, the microscope stage) 45° about the axis of rotation, using the SEM to measure the major axis L₁ and minor axis D_{1-45°} and calculating the aspect ratio P_{1-45°}, are repeated on n=100 randomly selected particles, based on which the average aspect ratio P₁ₐ, degree of variation A, and average index of spheroidization Q₁ₐ are calculated.

The average length L₁ₐ of the long axis of the particle can likewise be determined by repeating the measurement of the long axis (L₁) on n=100 randomly selected particles.

Other fine particles may be physically or chemically added to the oval-spherical organic polymer particles of the invention to form composite particles.

Examples of methods by which this may be done include (1) incorporating the fine particles at the time of particle production, (2) using the polarity of the ionic functional groups present at the surface of the particles following particle production to add the fine particles, and (3) addition by chemical bonding, such as addition polymerization, polycondensation or addition condensation.

As used herein, “other fine particles” refers to particles, either organic or inorganic, which are smaller than the oval-spherical organic polymer particles serving as the parent particles. The preferred size of such particles varies with the size of the oval-spherical organic polymer particles, but is generally in a range of about 0.01 to 1,000 μm.

Organic particles are exemplified by particles composed of the polymerizable monomers used to produce the inventive particles, curable particles, and organic pigments.

Illustrative examples of inorganic particles include those made of metals, metal oxides, hydrated metal oxides or inorganic pigments, such as copper powder, iron powder, gold powder, aluminum oxide, titanium oxide, zinc oxide, silicon oxide, tin oxide, copper oxide, iron oxide, magnesium oxide, manganese oxide, calcium carbonate, magnesium hydroxide and aluminum hydroxide.

These fine particles may be a commercial product which is either used without modification or which is used after first being surface modified with a coupling agent or other surface treatment agent.

In particular, when the oval-spherical organic polymer particles of the invention are used for optical applications, to control the refractive index and enhance the light diffusion properties, it is advantageous to add fine particles of a metal oxide, preferably titanium oxide, zinc oxide or silicon oxide, having a particle size of 0.01 to 500 μm. The fine particles used may be of a single type or may be a combination of two or more types.

These metal oxide fine particles can be added by, during production of the inventive particles, carrying out the reaction while admixing 0.1 to 50 wt % of the fine particles based on the total amount of polymerization components, or by inducing the uptake of these fine particles within the resulting oval-spherical organic polymer particles via physical or chemical adsorption, for example.

As noted above, the oval-spherical organic polymer particles of the invention have excellent light-diffusing properties, making them highly suitable for use as an additive for light-diffusing sheets. Specifically, a composition made up of the oval-spherical organic polymer particles of the invention, a binder and other additives, when coated or otherwise applied onto a clear substrate such as PET film, will form a light-diffusing layer. The resulting product is suitable for use as a light-diffusing sheet in such applications as liquid-crystal displays, overhead projectors, electronic billboards, televisions, and movie screens.

### EXAMPLES

Examples are given below by way of illustration and not by way of limitation.

[1] Oval-Spherical Organic Polymer Particles

### Example 1

The compounds shown below were mixed in the indicated proportions and the resulting mixture was added all at once to a 300 ml flask. Dissolved oxygen in the mixture was displaced with nitrogen, following which the flask contents were heated at an oil bath temperature of 65° C. for about 15 hours under stirring and a stream of nitrogen to give a styrene-sodium p-styrenesulfonate copolymer particle solution.

| | |
|---|---|
| Styrene | 28.9 g |
| Sodium p-styrenesulfonate | 7.2 g |
| Methanol | 82.8 g |
| Water | 55.2 g |
| Azobisisobutyronitrile (AIBN) | 1.0 g |
| Polyvinyl pyrrolidone (K-30) | 15.0 g |

Next, this particle solution was repeatedly washed and filtered three to five times with a water-methanol solvent mixture (weight ratio, 3:7) using a known suction filtration apparatus, then vacuum dried, yielding oval-spherical organic polymer particles.

One hundred of the resulting particles were randomly sampled and their shapes examined under the above-mentioned scanning electron microscope, from which they were confirmed to be oval-spherical organic polymer particles having a major axis L₁ with an average length L₁ₐ of 45 μm and having a single continuous curved surface. The aspect ratio P₁ had an average value P₁ₐ of 2.9 and a degree of variation A of 19.6. The average index of spheroidization Q₁ₐ was 0.98. The melting point calculated from the temperature at which a melting peak was observed using a differential scanning calorimeter (DSC 6200; manufactured by Seiko Instrument) was 162° C. FIG. 1 shows a scanning electron micrograph of the oval-spherical organic polymer particles thus obtained.

### Example 2

Aside from using sodium methacryloyloxyethylsulfonate instead of sodium p-styrenesulfonate and using polyvinylpyrrolidone (K-90) instead of polyvinyl pyrrolidone (K-30), a styrene-sodium methacryloyloxyethylsulfonate copolymer particle solution was obtained in the same way as in Example 1.

The particle solution was washed, filtered and dried in the same way as in Example 1. One hundred of the resulting particles were then randomly sampled and their shapes examined under the scanning electron microscope, from which they were confirmed to be oval-spherical organic polymer particles having a major axis L₁ with an average length L₁ₐ of 74 μm and having a single continuous curved surface. The aspect ratio P₁ had an average value P₁ₐ of 2.3 and a degree of variation A of 14.7. The average index of spheroidization Q₁ₐ was 0.96, and the melting point was 131° C.

### Example 3

The compounds shown below were mixed in the indicated proportions and the resulting mixture was added all at once to a 300 ml flask. Dissolved oxygen in the mixture was displaced with nitrogen, following which the flask contents were heated at an oil bath temperature of 75° C. for about 15 hours under stirring and a stream of nitrogen to give a styrene-sodium p-styrenesulfonate copolymer particle solution.

| | |
|---|---|
| Styrene | 30.7 g |
| Sodium p-styrenesulfonate | 5.42 g |
| Methanol | 100.7 g |
| Water | 55.48 g |
| Azobisisobutyronitrile (AIBN) | 2.07 g |
| Polymer Stabilizer Solution A | 23.33 g |

Polymer Stabilizer Solution A is a methacrylic acid-sodium 2-hydroxyethyl methacryloyloxyethylsulfonate copolymer resin solution (resin content, 30 wt %; water-methanol solvent mixture (weight ratio, 3:7); MW=65,000).

Next, this particle solution was repeatedly washed and filtered three to five times with a water-methanol solvent mixture (weight ratio, 3:7) using a known suction filtration apparatus, then vacuum dried, yielding oval-spherical organic polymer particles.

One hundred of the resulting particles were randomly sampled and their shapes examined under the scanning electron microscope, from which they were confirmed to be oval-spherical organic polymer particles having a major axis L₁ with an average length L₁ₐ of 28 μm and having a single continuous curved surface. The aspect ratio P₁ had an average value P₁ₐ of 2.4 and a degree of variation A of 22.3. The average index of spheroidization Q₁ₐ was 0.97, and the melting point was 152° C. FIG. 2 shows a scanning electron micrograph of the oval-spherical organic polymer particles thus obtained.

### Example 4

The compounds shown below were mixed in the indicated proportions and the resulting mixture was added all at once to a 300 ml flask. Dissolved oxygen in the mixture was displaced with nitrogen, following which the flask contents were heated at an oil bath temperature of 75° C. for about 15 hours under stirring and a stream of nitrogen to give a styrene-sodium p-styrenesulfonate copolymer particle solution.

| | |
|---|---|
| Styrene | 30.7 g |
| Sodium p-styrenesulfonate | 5.42 g |
| Methanol | 50.7 g |
| THF | 6.9 g |
| Water | 48.9 g |
| Azobisisobutyronitrile (AIBN) | 2.07 g |
| Polymer Stabilizer Solution B | 16.33 g |
| Polyvinylpyrrolidone (K-60) aqueous solution | 3.82 g |
| (water, 45 wt %) | |

Polymer Stabilizer Solution B is a methacrylic acid-sodium 2-hydroxyethyl methacryloyloxyethylsulfonate-methacrylic acid copolymer resin solution (resin content, 30 wt %; water-methanol solvent mixture (weight ratio, 2:8); MW=35,000).

Next, this particle solution was repeatedly washed and filtered three to five times with a water-methanol solvent mixture (weight ratio, 3:7) using a known suction filtration apparatus, then vacuum dried, yielding oval-spherical organic polymer particles.

One hundred of the resulting particles were randomly sampled and their shapes examined under the scanning electron microscope, from which they were confirmed to be oval-spherical organic polymer particles having a major axis L₁ with an average length L₁ₐ of 19 μm and having a single continuous curved surface. The aspect ratio P₁ had an average value P₁ₐ of 2.1 and a degree of variation A of 21.8. The average index of spheroidization Q₁ₐ was 0.97, and the melting point was 151° C.

### Example 5

Aside from adding 1.8 g of sodium chloride, a styrene-sodium p-styrenesulfonate copolymer particle solution was obtained in the same way as in Example 1.

The particle solution was washed, filtered and dried in the same way as in Example 1. One hundred of the resulting particles were then randomly sampled and their shapes examined under the scanning electron microscope, from which it was confirmed that they were oval-spherical organic polymer particles having a major axis L₁ with an average length L₁ₐ of 46 μm and having a single continuous curved surface. The aspect ratio P₁ had an average value P₁ₐ of 4.9 and a degree of variation A of 15.8. The average index of spheroidization Q₁ₐ was 0.97, and the melting point was 162° C. FIG. 3 shows a scanning electron micrograph of the oval-spherical organic polymer particles thus obtained.

### Comparative Example 1

The compounds shown below were mixed in the indicated proportions and the resulting mixture was added all at once to a 300 ml flask. Dissolved oxygen in the mixture was displaced with nitrogen, following which the flask contents were heated at an oil bath temperature of 65° C. for about 15 hours under stirring and a stream of nitrogen to give a styrene/n-butyl acrylate copolymer particle solution.

| | |
|---|---|
| Styrene | 41.3 g |
| n-Butyl acrylate | 10.3 g |
| Methanol | 138.0 g |
| Azobisisobutyronitrile (AIBN) | 2.4 g |
| Polyvinyl pyrrolidone (K-30) | 9.0 g |

The particle solution was washed, filtered and dried in the same way as described above. One hundred of the resulting particles were then randomly sampled and their shapes examined under the scanning electron microscope, from which they were confirmed to be spherical particles having an average particle diameter of 7.2 μm. Oval-spherical particles with a high aspect ratio were not obtained. The melting point was 76° C.

### Comparative Example 2

Aside from using p-methylstyrene instead of sodium p-styrenesulfonate, a styrene-p-methylstyrene copolymer solution was obtained in the same way as in Example 1. However, the solution viscosity was high and resinification occurred, making it impossible to obtain particles.

### Comparative Example 3

Aside from using the same amount of methanol instead of water, a styrene-p-methylstyrene copolymer particle solution was prepared in the same way as in Comparative Example 2. After washing and drying, 100 of the resulting particles were randomly sampled and their shapes examined under the scanning electron microscope, from which they were confirmed to be spherical particles having an average particle diameter of 2.3 μm. Oval-spherical particles with a high aspect ratio were not obtained. The melting point was 109° C.

### Comparative Example 4

Aside from using the same amount of ethanol instead of water and changing the oil bath temperature to 78° C., a styrene/p-methylstyrene copolymer particle solution was prepared in the same way as in Comparative Example 2. After washing and drying, 100 of the resulting particles were randomly sampled and their shapes examined under the scanning electron microscope, from which they were confirmed to be spherical particles having an average particle diameter of 13.9 μm. Oval-spherical particles with a high aspect ratio were not obtained. The melting point was 107° C.

The above examples of the invention and comparative examples are summarized in Table 1.

TABLE 1

| | | | | Average | | | |
|---|---|---|---|---|---|---|---|
| | | | | long axis | Average | Degree | Average index |
| | Ionic | Oval- | Melting | length | aspect | of | of |
| | functional | spherical | point | L₁ₐ | ratio | variation A | spheroidization |
| | groups | shape | (° C.) | (μm) | P₁ₐ | (%) | Q₁ₐ |
| Example 1 | yes | good | 162 | 45 | 2.9 | 19.6 | 0.98 |
| Example 2 | yes | good | 131 | 74 | 2.3 | 14.7 | 0.96 |
| Example 3 | yes | good | 152 | 28 | 2.4 | 22.3 | 0.97 |
| Example 4 | yes | good | 151 | 19 | 2.1 | 21.8 | 0.97 |
| Example 5 | yes | good | 162 | 46 | 4.9 | 15.8 | 0.97 |
| Comparative | no | NG | 76 | 7.2* | <1.1 | <1.0 | 0.99 |
| Example 1 | | | | | | | |
| Comparative | no | NG | — | — | — | — | — |
| Example 2 | | | | | | | |
| Comparative | no | NG | 109 | 2.3* | <1.1 | <1.0 | 0.98 |
| Example 3 | | | | | | | |
| Comparative | no | NG | 107 | 13.9* | <1.1 | <1.0 | 0.97 |
| Example 4 | | | | | | | |

In Comparative Examples 1, 3 and 4, the asterisk (*) signifies a spherical average diameter.
Good: Oval-spherical particles having a single continuous curved surface were obtained.
NG: Oval-spherical particles having a single continuous curved surface were not obtained.
—: Not measurable

To verify the shapes of the oval-spherical organic polymer particles obtained in each of the above examples of the invention, microtomed sections were prepared and examined as follows.

Procedure for Shape Verification in Sectioned Planes

An epoxy embedding resin (Quetol 812), curing agents (MNA, DDSA) and an accelerator (DMP-30) (the embedding resin, curing agents and accelerator were all products of Nisshin-EM Corporation) were blended together with a small quantity of the particles obtained in Example 1 and thoroughly mixed, following which the mixture was charged into a plastic mold (silicone embedding plates) and cured at 80° C. for 3 hours. The cured material was then removed from the mold, yielding a sample block.

Using an ultramicrotome (Leica Microsystems Japan), the block was trimmed, then cut into thin-film specimens having a thickness of about 100 nm. The thin-film specimens were dyed with ruthenium tetraoxide, completing the preparation of light-transmitting specimens.

The resulting light-transmitting samples were placed under a scanning transmission electron microscope (S-4800 STEM, manufactured by Hitachi High Technologies Corporation; 300 to 10,000×) and randomly cut particle cross-sections on the specimen were examined, from which the outside shapes of the particles were found to have a single continuous curved surface free of undesirable surface irregularities and boundary points. Most of the shapes were circular, substantially circular, or elliptical.

In Examples 2 to 5 of the invention, microscopic examination carried out in the same way showed that, here too, the outside shapes of the particles had a single continuous curved surface free of undesirable surface irregularities and boundary points. Most of shapes in these examples were circular, substantially circular, or elliptical.

As shown above, the polymer particles of Examples 1 to 5 produced using an organic monomer having an ionic functional group were oval-spherical particles having a single continuous curved surface, a high aspect ratio, and a small degree of variation.

By contrast, the polymer particles of Comparative Examples 1, 3 and 4 produced using an organic monomer lacking an ionic functional group were spherical particles. In these cases, oval-spherical particles having a high aspect ratio were not obtained.

[2] Light-Diffusing Sheet

### Example 6

The following ingredients were mixed to form a composition, which was then coated with a bar coater having a gap height of 100 μm onto one side of a 100 μm thick PET film (the PET film used here and below was E-500 produced by Toyobo Co., Ltd.). After coating, hot-air drying was carried out with a dryer, thereby forming Light-Diffusing Sheet 1.

| | |
|---|---|
| Binder resin: acrylic resin | 20 g |
| Polymer particles: Oval-spherical particles of Example 1 | 5 g |
| Water: | 2 g |
| Acrylic resin: Joncryl 734, made by Johnson Polymer | |
| (the same applies below) | |

### Example 7

The following ingredients were mixed to form a composition, which was then coated with a bar coater having a gap height of 100 μm onto one side of a 100 μm thick PET film. After coating, hot-air drying was carried out with a dryer, thereby forming Light-Diffusing Sheet 2.

| | |
|---|---|
| Binder resin: acrylic resin | 20 g |
| Polymer particles: Oval-spherical particles of Example 3 | 5 g |
| Water: | 2 g |

### Comparative Example 5

The following ingredients were mixed to form a composition, which was then coated with a bar coater having a gap height of 100 μm onto one side of a 100 μm thick PET film. After coating, hot-air drying was carried out with a dryer, thereby forming Light-Diffusing Sheet 3.

| | |
|---|---|
| Binder resin: acrylic resin | 20 g |
| Polymer particles: Spherical particles of Comparative Example 4 | 5 g |
| Water: | 2 g |

### Comparative Example 6

The following ingredients were mixed to form a composition, which was then coated with a bar coater having a gap height of 100 μm onto one side of a 100 μm thick PET film. After coating, hot-air drying was carried out with a dryer, thereby forming Light-Diffusing Sheet 4.

| | |
|---|---|
| Binder resin: acrylic resin | 20 g |
| Water: | 2 g |

Evaluation of Light Diffusing Properties and Light Collecting Properties

Light transmittance by the above Light-Diffusing Sheets 1 to 4 was measured with a haze meter (NDH 2000, manufactured by Nippon Denshoku Industries Co., Ltd.).

A darkroom in the shape of a cubical box having a square hole formed only on the top face thereof was built. Each of Light-Diffusing Sheets 1 to 4 was in turn affixed thereon so as to cover the square hole, following which a light bulb-shaped fluorescent light was placed at the interior of the box-shaped darkroom, and the brightness visible head-on when viewed from above the respective Light-Diffusing Sheets 1 to 4 and perpendicular to the top face of the darkroom was observed. The brightness visible from above the respective Light-Diffusing Sheets 1 to 4 and at an angle of 45° to the top face of the darkroom was also observed. Those results are shown in Table 2.

In performing these tests, the light bulb-shaped fluorescent light used in the brightness test was adjusted to 100 V, and the light bulb was securely positioned at the center of the bottom face within the box. Moreover, observation was carried out at a viewing position located 50 cm above the top face of the darkroom. Observations for each of the light-diffusing sheets were conducted out under the same conditions.

TABLE 2

| | Light- | | | Total light | Diffuse | | |
|---|---|---|---|---|---|---|---|
| | diffusing | Particles | Haze | transmittance | transmittance | Brightness | Brightness |
| | sheet | used | (%) | (%) | (%) | (head-on) | (45°) |
| Example 6 | 1 | EX 1 | 97.5 | 91.3 | 89.3 | Good | Good |
| Example 7 | 2 | EX 3 | 93.6 | 90.8 | 89.4 | Good | Good |
| Comparative | 3 | CE 4 | 96.2 | 91.4 | 79.8 | Fair | Marginal |
| Example 5 | | | | | | | |
| Comparative | 4 | none | 0.27 | 92.6 | 0.25 | NG | NG |
| Example 6 | | | | | | | |

Good: bright
Fair: somewhat bright
Marginal: somewhat dark
NG: light merely passes through

As is apparent from Table 2, the polymer particle-containing Light-Diffusing Sheets 1 to 3 obtained in Examples 6 and 7 of the invention and Comparative Example 5 had haze. In particular, Light-Diffusing Sheets 1 and 2 which contained oval-spherical organic polymer particles according to the invention were confirmed to have sufficient light-diffusing properties.

Moreover, Light-Diffusing Sheets 1 and 2 obtained in Examples 6 and 7, when viewed (head-on, and at an angle of 45°) in the brightness test, were brighter than the Light-Diffusing Sheet 3 of Comparative Example 5 in which spherical particles were used. This demonstrated that using the oval-spherical particles of the present invention in a light-diffusing sheet increases not only the light-diffusing properties, but also the light-collecting properties.

Japanese Patent Application No. 2005-255319 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. An oval-spherical organic polymer particle comprising a polymer of a first organic monomer having an ionic functional group and a polymerizable group and a second organic monomer that is polymerizable therewith,
wherein the particle has a single continuous curved surface and has an aspect ratio P₁, calculated as P₁=L₁/D₁, wherein L₁ is the major axis and D₁ is the minor axis of a projected two-dimensional image obtained by shining light onto the particle from a direction orthogonal to the long axis of the particle, which satisfies the relationship P₁≧1.8.

2. The particle of claim 1, wherein the major axis L₁ has an average length L₁ₐ of from 0.001 to 80 μm.

3. The particle of claim 1 which has a melting point of at least 120° C.

4. The particle of claim 1, wherein the first organic monomer is water-soluble.

5. A method of producing the oval-spherical organic polymer particle of claim 1, the method being comprised of solution polymerizing the first organic monomer having an ionic functional group and a polymerizable group with the second organic monomer that is polymerizable therewith in a solvent mixture of water and a water-soluble organic solvent.

6. The method of claim 5, wherein the first organic monomer and the second organic monomer are used in a ratio of from 10:90 to 40:60.

7. The method of claim 5, wherein the first organic monomer is water-soluble.

8. A resin composition which contains the oval-spherical organic polymer particle of claim 1.

9. A light-diffusing sheet obtained using the oval-spherical organic polymer particle of claim 1.
